(19) United States
(12) Patent Application Publication
(10) Pub. No.: US 2024/0397567 A1
(43) Pub. Date: Nov. 28, 2024

(54) MIDHAUL CONTROL CONNECTION ADDITION

(71) Applicant: RAKUTEN MOBILE, INC., Tokyo (JP)

(72) Inventor: Ramkumar MOORTHY, Tokyo (JP)

(21) Appl. No.: 18/321,775

(22) Filed: May 23, 2023

(51) Int. Cl. H04W 76/15; H04L 41/0659; H04L 43/0829; H04W 28/08

(52) U.S. Cl. CPC H04W 76/15; H04L 41/0659; H04L 43/0829; H04W 28/0967

(57) ABSTRACT

Midhaul control connection addition is performed by requesting, from the transport layer micro-service through the first midhaul control connection, a second midhaul control connection utilizing a second midhaul connection protocol address, and establishing the second midhaul control connection utilizing the second midhaul connection protocol address.

### BACKGROUND

### Technical Field

This description relates to midhaul control connection addition.

### Background

Radio Access Networks (RAN) utilizing Open RAN (O-RAN), where the interfaces and protocols between the RAN components are open and interoperable, have emerged. Open RAN splits the functions of an access point of a cell site among a central unit (CU), a distributed unit (DU), and a radio unit (RU). In some O-RAN systems, instances of a CU and a DU exist as applications executed in a cloud native environment.

### SUMMARY

According to at least some embodiments of the subject disclosure, midhaul control connection addition is performed by requesting, from the transport layer micro-service through the first midhaul control connection, a second midhaul control connection utilizing a second midhaul connection protocol address, and establishing the second midhaul control connection utilizing the second midhaul connection protocol address.

Some embodiments include the instructions in a computer program, the method performed by the processor executing the instructions of the computer program, and an apparatus that performs the method. In some embodiments, the apparatus includes a controller including circuitry configured to perform the operations in the instructions.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for midhaul control connection addition, according to at least some embodiments of the subject disclosure.

FIG. 2 is a schematic diagram of a data center for midhaul control connection addition, according to at least some embodiments of the subject disclosure.

FIG. 3 is an operational flow for midhaul control connection addition, according to at least some embodiments of the subject disclosure.

FIG. 4 is an operational flow for distributed unit application operation, according to at least some embodiments of the subject disclosure.

FIG. 5 is an operational flow for distribution unit application provisioning, according to at least some embodiments of the subject disclosure.

FIG. 6 is a block diagram of a hardware configuration for midhaul control connection addition, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

To execute a CU application or a DU application in a cloud native environment, the application is divided into micro-services, each micro-service performing a network function, and each micro-service is provisioned in a container on a server in the cloud native environment. For example, KUBERNETES is a popular platform for orchestrating containers in cloud native environments. A micro-service provisioned in a container on in a cloud native environment is referred to as a Network Function Virtualization (NFV) or a Cloud Network Function (CNF).

In some O-RAN systems, the cloud environment that deploys CNF-based applications includes three types of data centers: a central data center, a regional data center, and an edge data center. In some systems, a CU application communicates with up to 85 DU applications. In some systems, each DU application of which communicates with up to 3 RUs. In some systems, each RU connects to many user terminals. In some systems, communication between a CU application and a DU application is referred to as midhaul. In some systems, the CU application communicates with a DU application over a control plane and a user plane. In some systems, the control plane is used for transmission of control messages. In some systems, the user plane is used for transmission of data messages.

In some systems, a DU application initializes the midhaul connection through a Stream Control Transmission Protocol (SCTP) RFC4960. In some systems, the midhaul connection is initialized with single-home, which means one protocol address is utilized, such as an Internet Protocol (IP) address. Once the SCTP is initialized, the DU application requests a midhaul control connection for the control plane, such as an F1 Control (F1-C) connection in accordance with 3^{rd} Generation Partnership Project (3GPP) 38.473. Once the CU application responds with an acknowledgement of the request, the midhaul control connection is established.

In single-home midhaul control connections, if there is an issue with the protocol address, then the midhaul connection must be reset, starting from the DU reinitializing the midhaul connection. In some cases, this causes terminal disconnection, dropped calls, outages, etc. Some systems avoid this by having the DU application initialize the midhaul connection with multi-home, which means two or more protocol addresses are utilized. In some multi-home connections, an instance of a transport layer micro-service of the DU application is provisioned for each protocol address. In some multi-home connections, the terminals that are connected to the DU application are associated with one of the protocol addresses, and therefore are handled by one of the instances of the transport layer micro-service. In some multi-home connections, if there is an issue with one of the protocol addresses, the terminals are switched over to one of the other protocol addresses, and are then handled by the corresponding instance of the transport layer micro-service.

In some systems, there is a limited number of available protocol addresses, which may be insufficient to establish multi-home connections for all of the midhaul control connections in an O-RAN system. If a single-home midhaul control connection experiences packet drop, then a conversion to multi-home may be desired to avoid an outage, but doing so would also require the midhaul connection to be reset, starting from the DU reinitializing the midhaul connection.

At least some embodiments of the subject disclosure enable conversation of a single-home midhaul control connection to a multi-home midhaul control connection. In at least some embodiments, a method of midhaul control connection addition is utilized to add another midhaul control connection through another protocol address without resetting the midhaul connection. In at least some embodiments, the instance of the transport layer micro-service of the DU application provisioned for the current protocol address associates the connected terminals with both the current protocol address and an additional protocol address. Initially, the instance of the transport layer micro-service of the DU application continues to utilize the current protocol address for all control messages. If there is an issue with the current protocol address, then the instance of the transport layer micro-service of the DU application discontinues transmission through the current protocol address and transmits control messages through the additional protocol address. In some DU applications, the use of the single instance of the transport layer micro-service to associate with both the current protocol address and the additional protocol address yields greater recovery efficiency when there is an issue with a protocol address than using a multi-home midhaul control connection. In some DU applications, the use of the single instance of the transport layer micro-service to associate with both the current protocol address and the additional protocol address is more efficiently managed than using a multi-home midhaul control connection.

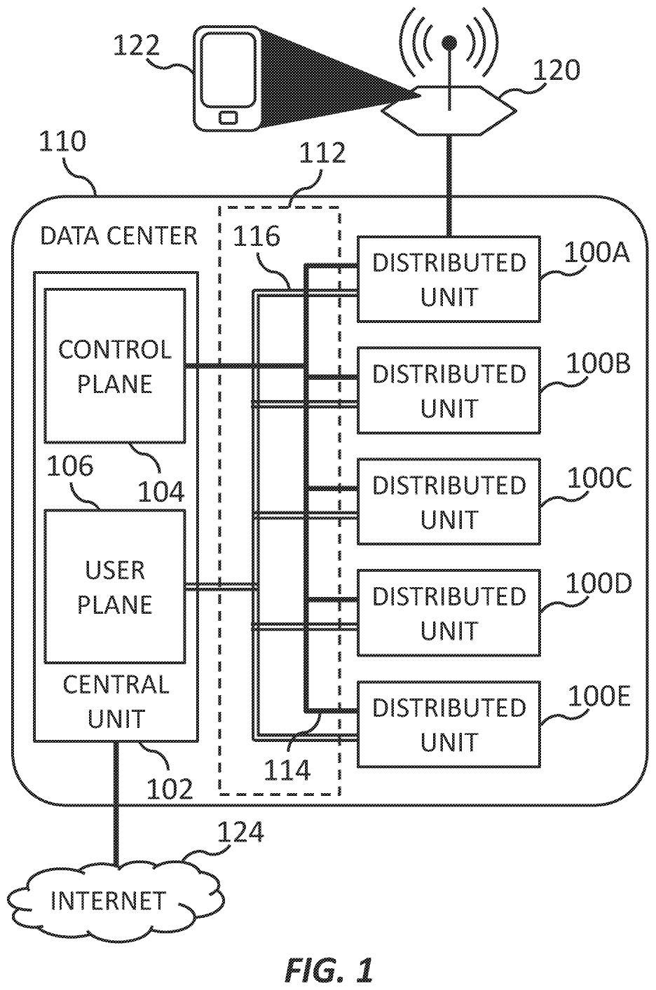

FIG. 1 is a schematic diagram of a system for midhaul control connection addition, according to at least some embodiments of the subject disclosure. The system includes a data center 110 and an access point 120. In at least some embodiments, the system enables communication between a terminal 122 and an internet 124. In at least some embodiments, data center 110 is part of a radio access network, which is a wireless communication network including access points, such as access point 120. In at least some embodiments, the radio access network is configured to operate under 4G standards, 5G standards, or any other wide area radio access network protocol. In at least some embodiments, data center 110 is a regional data center or an edge data center.

Data center 110 performs functions of distributed unit 100A, distributed unit 100B, distributed unit 100C, distributed unit 100D, and distributed unit 100E. Data center 110 performs at least some functions of central unit 102. Central unit 102 communicates with distributed units 100A, 100B, 100C, 100D, and 100E through a midhaul connection 112. In at least some embodiments, data center 110 includes a plurality of servers. In at least some embodiments, data center 110 is part of a cloud native environment. In at least some embodiments, each server hosts one or more applications configured to perform the functions of central unit 102 to facilitate communication through the radio access network. In at least some embodiments, each server hosts one or more applications configured to perform the functions of distributed units 100A, 100B, 100C, 100D, and 100E to facilitate communication through the radio access network. In at least some embodiments, each server of data center 110 operates using a container management platform, such as KUBERNETES. In at least some embodiments, data center 110 hosts micro-services configured to perform the functions of distributed units 100A, 100B, 100C, 100D, and 100E and the functions of central unit 102.

Central unit 102 includes a control plane 104 and a user plane 106. In at least some embodiments, central unit 102 utilizes control plane 104 to communicate control messages with the distributed units through a midhaul control connection 114. In at least some embodiments, central unit 102 utilizes user plane 106 to communicate data with the distributed units through a midhaul data connection 116. In at least some embodiments, control plane 104 and user plane 106 are micro-services hosted by data center 110 as part of central unit 102. In at least some embodiments, central unit 102 is in communication with up to 86 distributed units, such as distributed units 100A, 100B, 100C, 100D, and 100E.

Each distributed unit among distributed units 100A, 100B, 100C, 100D, and 100E is in communication with an access point. For example, distributed unit 100A is communication with access point 120. Devices connected to access point 120, such as terminal 122, communicate with internet 124 through distributed unit 100A and central unit 102. Distributed units 100B, 100C, 100D, and 100E are in communication with other access points. In at least some embodiments, each distributed unit among distributed units 100A, 100B, 100C, 100D, and 100E is in communication with 3 radio units of an access point. In at least some embodiments, each of the 3 radio units covers 120 degrees of the area around the access point.

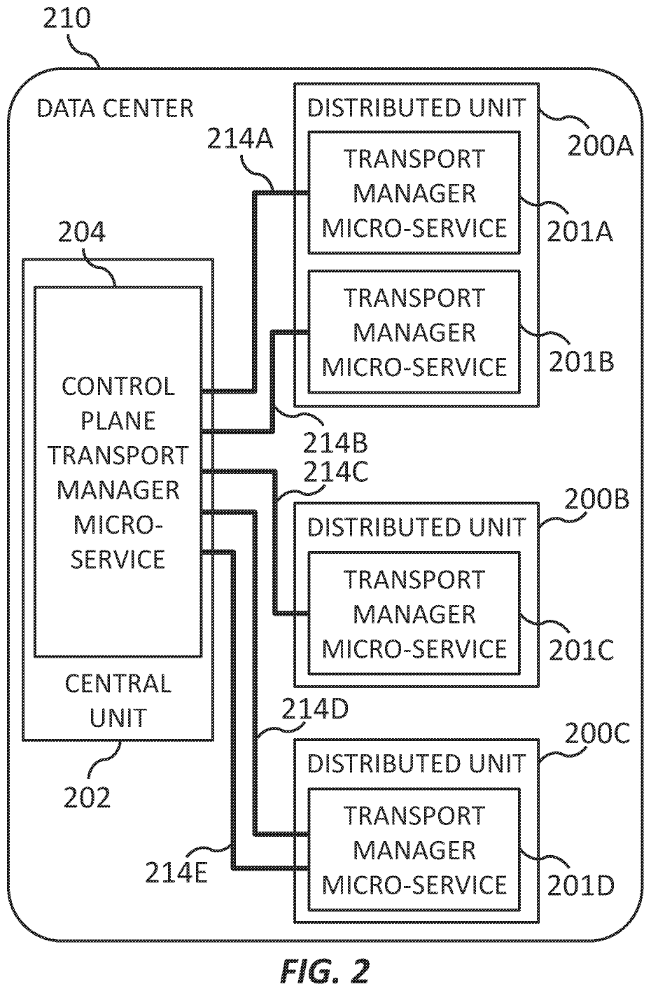

FIG. 2 is a schematic diagram of a data center 210 for midhaul control connection addition, according to at least some embodiments of the subject disclosure. Data center 210 performs functions of distributed unit 200A, distributed unit 200B, and distributed unit 200C. Data center 210 performs at least some functions of central unit 202.

Central unit 202 includes a control plane transport manager micro-service 204 configured to relay control messages between central unit 202 and each connected distributed unit, such as distributed unit 200A, distributed unit 200B, and distributed unit 200C, through midhaul control connections, such as midhaul control connection 214A, midhaul control connection 214B, midhaul control connection 214C, midhaul control connection 214D, and midhaul control connection 214E.

The structure and function of data center 210, distributed unit 200A, distributed unit 200B, distributed unit 200C, central unit 202, control plane transport manager micro-service 204, and midhaul control connections 214A, 214B, 214C, 214D, and 214E are substantially equivalent to the structure and function of data center 110, distributed unit 100A, distributed unit 100B, distributed unit 100C, and central unit 102, control plane 104, and midhaul control connection 114 of FIG. 1, respectively.

Distributed unit 200A includes a transport manager micro-service 201A and a transport manager micro-service 201B, each configured to relay control messages between distributed unit 200A and central unit 202. Transport manager micro-service 201A communicates with control plane transport manager micro-service 204 through midhaul control connection 214A. Transport manager micro-service 201B communicates with control plane transport manager micro-service 204 through midhaul control connection 214B. In at least some embodiments, midhaul control connection 214A differs from midhaul control connection 214B in the protocol address of distributed unit 200A used for communication. In at least some embodiments, the midhaul connection between central unit 202 and distributed unit 200A has been established as a multi-home connection. As a result of establishment as a multi-home connection, multiple transport manager micro-service instances were provisioned, each with a different protocol address. In at least some embodiments, transport manager micro-service 201A relays control messages for some devices connected to an access point of distributed unit 200A while transport manager micro-service 201B relays control messages for other devices connected to the access point of distributed unit 200A. In at least some embodiments, if there is an issue with midhaul control connection 214A, then transport manager micro-service 201B relays control messages for all devices connected to the access point of distributed unit 200A through midhaul control connection 214B.

Distributed unit 200B includes a transport manager micro-service 201C configured to relay control messages between distributed unit 200B and central unit 202. Transport manager micro-service 201C communicates with control plane transport manager micro-service 204 through midhaul control connection 214C. In at least some embodiments, the midhaul connection between central unit 202 and distributed unit 200B has been established as a single-home connection. As a result of establishment as a single-home connection, one transport manager micro-service instance was provisioned. In at least some embodiments, transport manager micro-service 201C relays control messages for all devices connected to an access point of distributed unit 200B. In at least some embodiments, if there is an issue with midhaul control connection 214C, then control connection 214C is reset, resulting in the possibility of an outage.

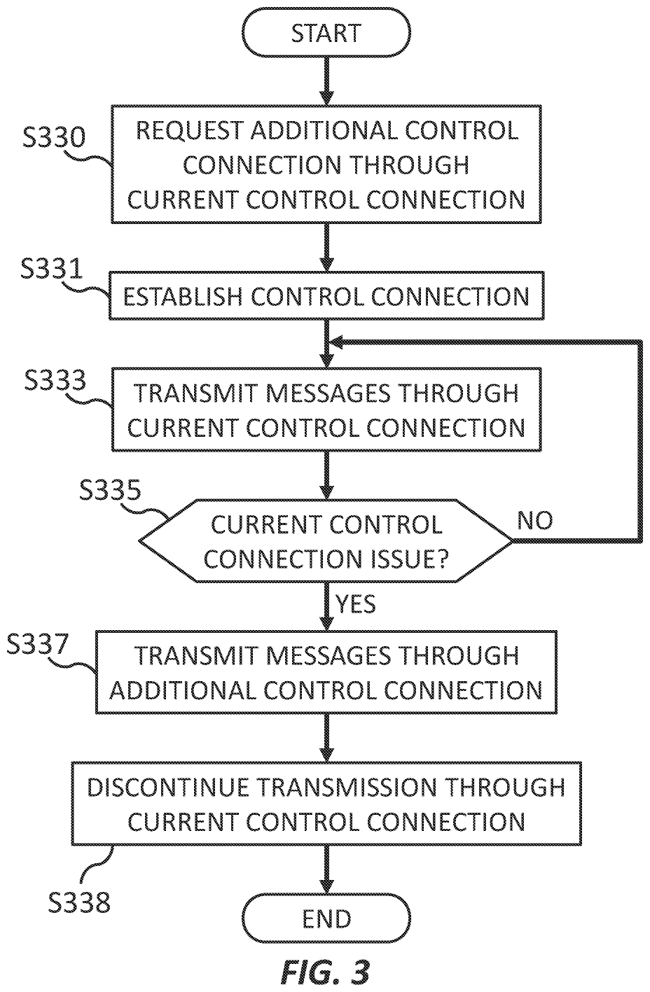

Distributed unit 200C includes a transport manager micro-service 201D configured to relay control messages between distributed unit 200C and central unit 202. Transport manager micro-service 201D communicates with control plane transport manager micro-service 204 through midhaul control connection 214D. In at least some embodiments, the midhaul connection between central unit 202 and distributed unit 200C has been established as a single-home connection. As a result of establishment as a single-home connection, one transport manager micro-service instance was provisioned. In at least some embodiments, transport manager micro-service 201D relays control messages for all devices connected to an access point of distributed unit 200C. In at least some embodiments, additional midhaul control connection 214E was added while distribution unit 200C was operating to enable communication between devices connected to the access point and an internet. In at least some embodiments, additional midhaul control connection 214E was added by performing the operational flow shown in FIG. 3, which will be explained hereinafter. In at least some embodiments, midhaul control connection 214D differs from midhaul control connection 214E in the protocol address of distributed unit 200C used for communication. In at least some embodiments, transport manager micro-service 201D relays control messages for all devices connected to an access point of distributed unit 200B through midhaul control connection 214D. In at least some embodiments, if there is an issue with midhaul control connection 214C, then transport manager micro-service 201D relays control messages for all devices connected to the access point of distributed unit 200C through midhaul control connection 214E.

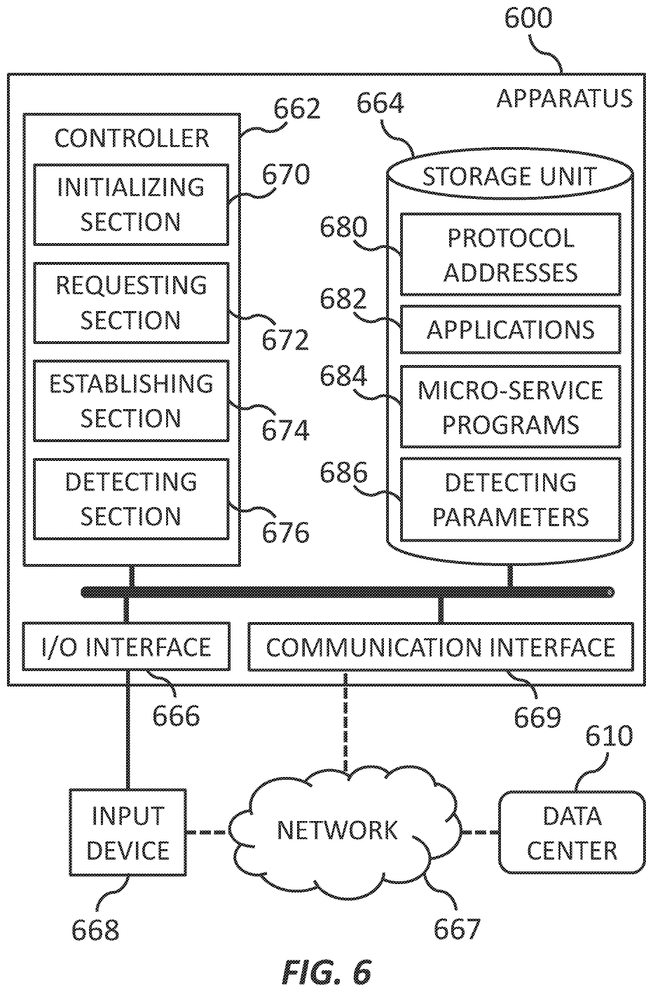

FIG. 3 is an operational flow for midhaul control connection addition, according to at least some embodiments of the subject disclosure. The operational flow provides a method of midhaul control connection addition. In at least some embodiments, the method is performed by a transport manager micro-service or another micro-service of a distributed unit application. In at least some embodiments, the method is performed by a controller of an apparatus including sections for performing certain operations, such as the controller and apparatus shown in FIG. 6, which will be explained hereinafter.

At S330, a requesting section of the controller requests an additional midhaul control connection through a current midhaul control connection. In at least some embodiments, the current midhaul control connection utilizes a current midhaul connection protocol address. In at least some embodiments, the requesting section requests, from the transport layer micro-service through a first midhaul control connection, a second midhaul control connection utilizing a second midhaul connection protocol address. In at least some embodiments, the requesting section causes the transport manager micro-service or another micro-service of a distributed unit application to request the additional midhaul control connection through the current midhaul control connection. In at least some embodiments, the requesting section transmits the request to a central unit application. In at least some embodiments, the current midhaul control connection is an F1-C connection established using SCTP.

At S331, an establishing section of the controller establishes the additional midhaul control connection. In at least some embodiments, the establishing section establishes the second midhaul control connection utilizing the second midhaul connection protocol address. In at least some embodiments, the establishing section establishes the additional midhaul control connection for use by the same instance of the transport manager micro-service of the distributed unit application that uses the current midhaul control connection. In at least some embodiments, the establishing section establishes the additional midhaul control connection for as a redundancy of the current midhaul control connection. In at least some embodiments, the establishing section associates devices communicating through the distributed unit application with the additional midhaul connection protocol address in addition to the current midhaul connection protocol address. In at least some embodiments, the establishing section associates, by the transport layer micro-service, a device communicating through the distributed unit application with the second midhaul connection protocol address, wherein the device is associated with both the first midhaul connection protocol address and the second midhaul connection protocol address. In at least some embodiments, the establishing section causes the transport layer micro-service to associate the devices communicating through the distributed unit application with the additional midhaul connection protocol address.

At S333, the transport layer micro-service transmits control messages through the current midhaul control connection. In at least some embodiments, the transport layer micro-service transmits, through the first midhaul control connection, a control message from the distributed unit application to the central unit application utilizing the first midhaul connection protocol address. In at least some embodiments, the controller or a section thereof causes the transport layer micro-service to transmit control messages through the current midhaul control connection.

At S335, the controller or a section thereof determines whether there is an issue with the current midhaul control connection. In at least some embodiments, a detecting section of the controller detects an issue with the first midhaul control connection. In at least some embodiments, the transport layer micro-service detects an issue with the current midhaul control connection. In at least some embodiments, an issue with the current midhaul control connection is caused by a platform issue on a server within the data center hosting the distributed unit application, an infra-network connection issue, an issue with another application, etc. In at least some embodiments, an issue with the current midhaul control connection prevents or impedes communication through the current midhaul control connection. If the controller determines that there is not any issue with the current midhaul control connection, then the operational flow returns to control message transmission at S333. If the controller determines that there is an issue with the current midhaul control connection, then the operational flow proceeds to control message transmission at S337.

At S337, the transport layer micro-service transmits control messages through the additional midhaul control connection. In at least some embodiments, the transport layer micro-service transmits, through the second midhaul control connection, a control message from the distributed unit application to the central unit application utilizing the second midhaul connection protocol address. In at least some embodiments, the controller or a section thereof causes the transport layer micro-service to transmit control messages through the additional midhaul control connection. In at least some embodiments, the same transport layer micro-service instance that transmits control messages through the current midhaul control connection at S337 transmits control messages through the additional midhaul control connection. In at least some embodiments, the transport layer micro-service begins transmission of control messages through the second midhaul control connection in response to detecting the issue.

At S338, the transport layer micro-service discontinues transmission of control messages through the current midhaul control connection. In at least some embodiments, the transport layer micro-service discontinues transmission of control messages through the first midhaul control connection in response to detecting the issue. In at least some embodiments, the controller or a section thereof causes the transport layer micro-service to transmit control messages through the additional midhaul control connection.

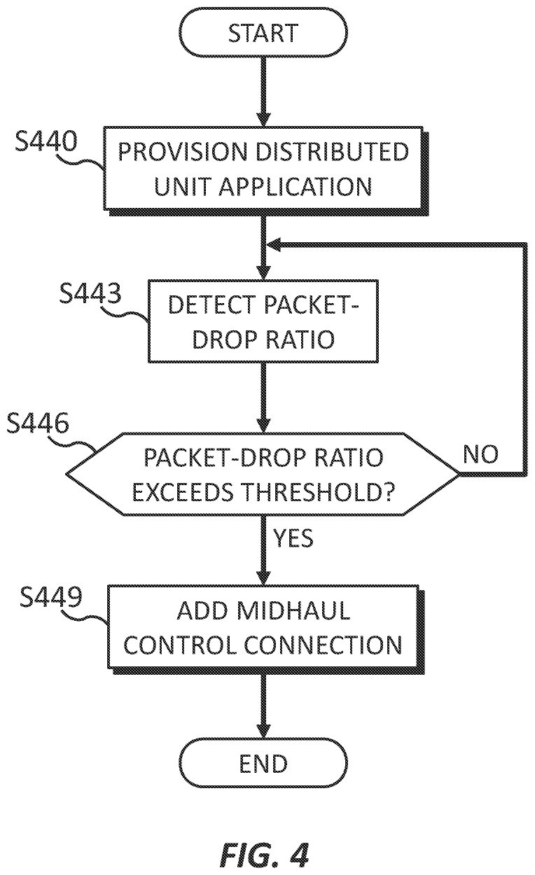

FIG. 4 is an operational flow for distributed unit application operation, according to at least some embodiments of the subject disclosure. The operational flow provides a method of distributed unit application operation. In at least some embodiments, the method is performed by a controller of an apparatus including sections for performing certain operations, such as the controller and apparatus shown in FIG. 6, which will be explained hereinafter.

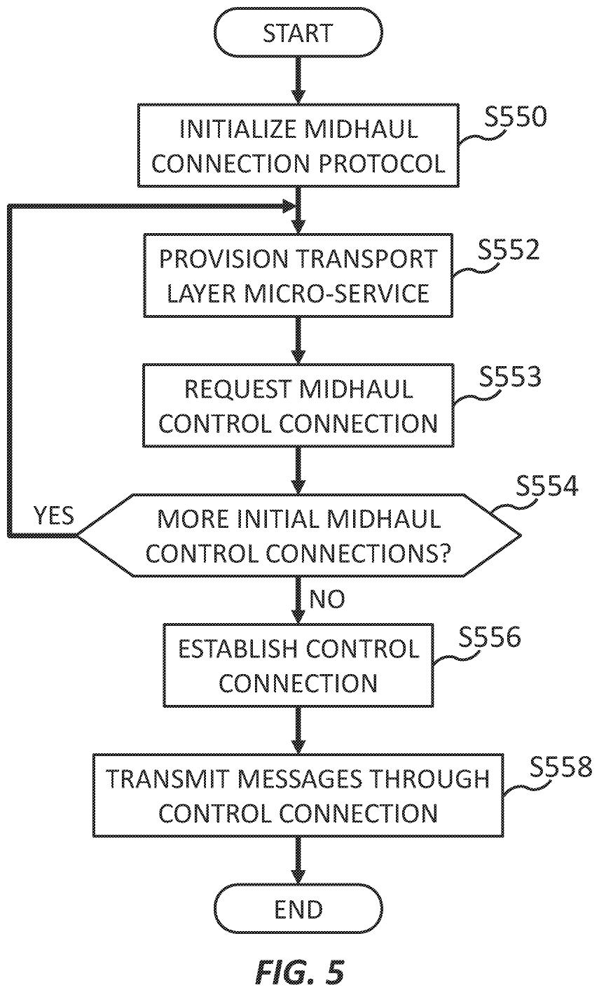

At S440, the controller or a section thereof provisions a distributed unit application. In at least some embodiments, the controller provisions the distributed unit application on a server in a data center. In at least some embodiments, the controller provisions the distributed unit application in a container for execution in a container platform hosted by the server in the data center. In at least some embodiments, the controller provisions the distributed unit application for communication with a central unit application through at least one midhaul control connection. In at least some embodiments, the controller performs the operational flow shown in FIG. 5, which will be explained hereinafter.

At S443, a detecting section of the controller detects a packet-drop ratio. In at least some embodiments, the detecting section detects a packet-drop ratio through the first midhaul control connection. In at least some embodiments, the detecting section detects the packet-drop ratio through the current midhaul control connection. In at least some embodiments, the detecting section tracks acknowledgements of control messages sent through the current midhaul control connection. In at least some embodiments, the detecting section causes the transport layer micro-service or another micro-service of the distributed unit application to detect the packet-drop ratio through the current midhaul control connection.

At S446, the controller or a section thereof determines whether the packet-drop ratio exceeds a threshold. In at least some embodiments, the threshold is a value representing a packet-drop ratio that indicates instability in a midhaul control connection. In at least some embodiments, the threshold value is between 30% and 50%. If the controller determines that the packet-drop ratio does not exceed the threshold, then the operational flow returns to packet-drop ratio detection at S443. If the controller determines that the packet-drop ratio exceeds the threshold, then the operational flow proceeds to midhaul control connection addition at S449.

At S449, the controller or at least one section thereof adds a midhaul control connection. In at least some embodiments, a requesting section and an establishing section add an additional midhaul control connection. In at least some embodiments, the controller performs the requesting, such as the additional midhaul control connection requesting operation at S330 of FIG. 3, and the establishing, such as the additional midhaul control connection establishing operation at S331 of FIG. 3, in response to the packet-drop ratio exceeding a threshold packet-drop ratio value. In at least some embodiments, the controller performs the operational flow shown in FIG. 3, previously explained herein.

FIG. 5 is an operational flow for distribution unit application provisioning, according to at least some embodiments of the subject disclosure. The operational flow provides a method of distribution unit application provisioning. In at least some embodiments, the method is performed by a controller of an apparatus including sections for performing certain operations, such as the controller and apparatus shown in FIG. 6, which will be explained hereinafter.

At S550, an initializing section of the controller initializes a midhaul connection protocol. In at least some embodiments, the initializing section initializes a midhaul connection protocol from a distributed unit application to a control unit application to utilize a first midhaul connection protocol address. In at least some embodiments, the initializing section causes a micro-service of the distributed unit application to initialize the midhaul connection protocol. In at least some embodiments, the initializing section initializes the midhaul connection protocol as SCTP in accordance with RFC4960.

At S552, the controller or a section thereof provisions a transport layer micro-service. In at least some embodiments, the controller provisions the transport layer micro-service to communicate control messages between the distributed unit application and the control unit application. In at least some embodiments, the controller causes a micro-service of the distributed unit to provision the transport layer micro-service. In at least some embodiments, the controller provisions the transport layer micro-service in a container for execution in the container platform hosted by the server in the data center of the distributed unit application.

At S553, a requesting section of the controller requests a midhaul control connection. In at least some embodiments, the requesting section requests, from the transport layer micro-service through a first midhaul connection protocol address, a first midhaul control connection between the distributed unit application and the control unit application. In at least some embodiments, the requesting section causes the transport manager micro-service or another micro-service of a distributed unit application to request the midhaul control connection. In at least some embodiments, the requesting section transmits the request to a central unit application.

At S554, the controller determines whether more initial midhaul control connections are to be requested. In at least some embodiments, more initial midhaul control connections are to be requested in cases where the midhaul connection protocol is initialized with multi-home. If the controller determines that more initial midhaul control connections are to be requested, then the operational flow returns to transport layer micro-service provisioning at S552 to provision another instance of the transport layer micro-service. If the controller determines that all initial midhaul control connections have been requested, then the operational flow proceeds to control connection establishment at S556.

At S556, an establishing section of the controller establishes a midhaul control connection. In at least some embodiments, the establishing section establishes the first midhaul control connection. In at least some embodiments, the establishing section establishes one midhaul control connection for each instance of the transport manager micro-service of the distributed unit application provisioned at operation S552 and iterations thereof. In at least some embodiments, the establishing section establishes only one midhaul control connection for a single transport layer micro-service of the distributed unit application. In at least some embodiments, the establishing section associates devices communicating through the distributed unit application with a midhaul connection protocol address of an instance of the transport manager micro-service provisioned at operation S552 and iterations thereof. In at least some embodiments, the establishing section associates with the first protocol address, by the transport layer micro-service, a device communicating through the distributed unit application. In at least some embodiments, the establishing section causes each instance of the transport layer micro-service to associate one or more devices communicating through the distributed unit application with the corresponding midhaul connection protocol address.

At S558, the transport layer micro-service transmits control messages through the midhaul control connection. In at least some embodiments, the transport layer micro-service transmits, through the first midhaul control connection, a control message from the distributed unit application to the central unit application utilizing the first midhaul connection protocol address. In at least some embodiments, the controller or a section thereof causes the transport layer micro-service to transmit control messages through the midhaul control connection. In at least some embodiments, the controller or a section thereof causes each instance of the transport layer micro-service to transmit control messages through the corresponding midhaul control connection.

FIG. 6 is a block diagram of a hardware configuration for midhaul control connection addition, according to at least some embodiments of the subject disclosure.

The exemplary hardware configuration includes apparatus 600, which communicates with network 667, data center 610 through network 667, and interacts with input device 668 either directly or through network 667. In at least some embodiments, apparatus 600 is a computer or other computing device that receives input or commands from input device 668. In at least some embodiments, apparatus 600 is integrated with input device 668. In at least some embodiments, apparatus 600 is a computer system that executes computer-readable instructions to perform operations for midhaul control connection addition.

Apparatus 600 includes a controller 662, a storage unit 664, an input/output interface 666, and a communication interface 669. In at least some embodiments, controller 662 includes a processor or programmable circuitry executing instructions to cause the processor or programmable circuitry to perform operations according to the instructions. In at least some embodiments, controller 662 includes analog or digital programmable circuitry, or any combination thereof. In at least some embodiments, controller 662 includes physically separated storage or circuitry that interacts through communication. In at least some embodiments, storage unit 664 includes a non-volatile computer-readable medium capable of storing executable and non-executable data for access by controller 662 during execution of the instructions. Communication interface 669 transmits and receives data from network 667. Input/output interface 666 connects to various input and output units, such as input device 668, via a parallel port, a serial port, a keyboard port, a mouse port, a monitor port, and the like to accept commands and present information. In some embodiments, storage unit 664 is external from apparatus 600.

Controller 662 includes initializing section 670, requesting section 672, establishing section 674, and detecting section 676. Storage unit 664 includes protocol addresses 680, applications 682, micro-service programs 684, and detecting parameters 686.

Initializing section 670 is the circuitry or instructions of controller 662 configured to initialize a midhaul connection protocol. In at least some embodiments, initializing section 670 is configured to initialize a midhaul connection protocol from a distributed unit application to a control unit application to utilize a first midhaul connection protocol address. In at least some embodiments, initializing section 670 records information to storage unit 664, such as in protocol addresses 680. In at least some embodiments, initializing section 670 includes sub-sections for performing additional functions, as described in the foregoing flow charts. In at least some embodiments, such sub-sections are referred to by a name associated with a corresponding function.

Requesting section 672 is the circuitry or instructions of controller 662 configured to request midhaul control connections. In at least some embodiments, requesting section 672 is configured to request, from the transport layer micro-service through a first midhaul connection protocol address, a first midhaul control connection between the distributed unit application and the control unit application. In at least some embodiments, requesting section 672 is configured to request, from the transport layer micro-service through a first midhaul control connection, a second midhaul control connection utilizing a second midhaul connection protocol address. In at least some embodiments, initializing section 670 utilizes information in storage unit 664, such as server identifiers, and records information to storage unit 664, such as in protocol addresses 680. In at least some embodiments, requesting section 672 includes sub-sections for performing additional functions, as described in the foregoing flow charts. In at least some embodiments, such sub-sections are referred to by a name associated with a corresponding function.

Establishing section 674 is the circuitry or instructions of controller 662 configured to establish midhaul control connections. In at least some embodiments, establishing section 674 is configured to establish the first midhaul control connection, and establish the second midhaul control connection utilizing the second midhaul connection protocol address. In at least some embodiments, establishing section 674 utilizes information from storage unit 664, such as protocol addresses 680, applications 682, and micro-service programs 684. In at least some embodiments, establishing section 674 includes sub-sections for performing additional functions, as described in the foregoing flow charts. In at least some embodiments, such sub-sections are referred to by a name associated with a corresponding function.

Detecting section 676 is the circuitry or instructions of controller 662 configured to detect connection issues and packet-drop ratios. In at least some embodiments, detecting section 676 is configured to detect an issue with the first midhaul control connection. In at least some embodiments, detecting section 676 is configured to detect a packet-drop ratio through the first midhaul control connection. In at least some embodiments, detecting section 676 utilizes information from storage unit 664, such as detecting parameters 686. In at least some embodiments, detecting section 676 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Accordingly, at least some embodiments of the subject disclosure are outlined by the scope of the following Supplemental Notes.

### Supplemental Note 1

A non-transitory computer-readable medium includes instructions executable by a processor to cause the processor to perform operations for midhaul control connection addition. The operations comprise transmitting, by a transport layer micro-service through a first midhaul control connection, a control message from the distributed unit application to the central unit application utilizing a first midhaul connection protocol address, requesting, from the transport layer micro-service through the first midhaul control connection, a second midhaul control connection utilizing a second midhaul connection protocol address, establishing the second midhaul control connection utilizing the second midhaul connection protocol address, and transmitting, by the transport layer micro-service through the second midhaul control connection, a control message from the distributed unit application to the central unit application utilizing the second midhaul connection protocol address.

### Supplemental Note 2

In the computer-readable medium of Supplemental Note 1, the establishing the second midhaul control connection includes associating, by the transport layer micro-service, a device communicating through the distributed unit application with the second midhaul connection protocol address. The device is associated with both the first midhaul connection protocol address and the second midhaul connection protocol address.

### Supplemental Note 3

In the computer-readable medium of Supplemental Note 1 or 2, the operations further comprise detecting an issue with the first midhaul control connection. In response to detecting the issue, further operations of discontinuing transmission of control messages through the first midhaul control connection and beginning transmission of control messages through the second midhaul control connection are performed.

### Supplemental Note 4

In the computer-readable medium of any one of Supplemental Notes 1-3, the operations further comprise detecting a packet-drop ratio through the first midhaul control connection and performing the requesting and the establishing in response to the packet-drop ratio exceeding a threshold packet-drop ratio value.

### Supplemental Note 5

In the computer-readable medium of any one of Supplemental Notes 1-4, the operations further comprise provisioning the distributed unit application on a server in a data center.

### Supplemental Note 6

In the computer-readable medium of Supplemental Note 5, the provisioning the distributed unit application includes initializing the midhaul connection protocol from the distributed unit application to the control unit application to utilize the first midhaul connection protocol address, provisioning the transport layer micro-service to communicate control messages between the distributed unit application and the control unit application, requesting, from the transport layer micro-service through the first midhaul connection protocol address, the first midhaul control connection between the distributed unit application and the control unit application, and establishing the first midhaul control connection.

### Supplemental Note 7

In the computer-readable medium of Supplemental Note 6, the establishing the first midhaul control connection includes associating with the first protocol address, by the transport layer micro-service, a device communicating through the distributed unit application.

### Supplemental Note 8

A method of midhaul control connection addition comprises transmitting, by a transport layer micro-service through a first midhaul control connection, a control message from the distributed unit application to the central unit application utilizing a first midhaul connection protocol address, requesting, from the transport layer micro-service through the first midhaul control connection, a second midhaul control connection utilizing a second midhaul connection protocol address, establishing the second midhaul control connection utilizing the second midhaul connection protocol address, and transmitting, by the transport layer micro-service through the second midhaul control connection, a control message from the distributed unit application to the central unit application utilizing the second midhaul connection protocol address.

### Supplemental Note 9

In the method of Supplemental Note 8, the establishing the second midhaul control connection includes associating, by the transport layer micro-service, a device communicating through the distributed unit application with the second midhaul connection protocol address. The device is associated with both the first midhaul connection protocol address and the second midhaul connection protocol address.

### Supplemental Note 10

The method of Supplemental Note 8 or 9 further comprises detecting an issue with the first midhaul control connection. In response to detecting the issue, further operations of discontinuing transmission of control messages through the first midhaul control connection, and beginning transmission of control messages through the second midhaul control connection are performed.

### Supplemental Note 11

The method of any one of Supplemental Notes 8-10 further comprises detecting a packet-drop ratio through the first midhaul control connection, and performing the requesting and the establishing in response to the packet-drop ratio exceeding a threshold packet-drop ratio value.

### Supplemental Note 12

The method of any one of Supplemental Notes 8-10 further comprises provisioning the distributed unit application on a server in a data center.

### Supplemental Note 13

In the method of Supplemental Note 12, the provisioning the distributed unit application includes initializing the midhaul connection protocol from the distributed unit application to the control unit application to utilize the first midhaul connection protocol address, provisioning the transport layer micro-service to communicate control messages between the distributed unit application and the control unit application, requesting, from the transport layer micro-service through the first midhaul connection protocol address, the first midhaul control connection between the distributed unit application and the control unit application, and establishing the first midhaul control connection.

### Supplemental Note 14

In the method of Supplemental Note 13, the establishing the first midhaul control connection includes associating with the first protocol address, by the transport layer micro-service, a device communicating through the distributed unit application.

### Supplemental Note 15

An apparatus for midhaul control connection addition comprises a controller including circuitry. The circuitry is configured to transmit, by a transport layer micro-service through a first midhaul control connection, a control message from the distributed unit application to the central unit application utilizing a first midhaul connection protocol address, request, from the transport layer micro-service through the first midhaul control connection, a second midhaul control connection utilizing a second midhaul connection protocol address, establish the second midhaul control connection utilizing the second midhaul connection protocol address, and transmit, by the transport layer micro-service through the second midhaul control connection, a control message from the distributed unit application to the central unit application utilizing the second midhaul connection protocol address.

### Supplemental Note 16

In the apparatus of Supplemental Note 15, the establishing the second midhaul control connection includes associating, by the transport layer micro-service, a device communicating through the distributed unit application with the second midhaul connection protocol address. The device is associated with both the first midhaul connection protocol address and the second midhaul connection protocol address.

### Supplemental Note 17

In the apparatus of Supplemental Note 15 or 16, the circuitry is further configured to detect an issue with the first midhaul control connection. In response to detecting the issue, further operations of discontinuing transmission of control messages through the first midhaul control connection; and beginning transmission of control messages through the second midhaul control connection are performed according to the configuration of the circuitry.

### Supplemental Note 18

In the apparatus of any one of Supplemental Notes 15-17, the circuitry is further configured to detect a packet-drop ratio through the first midhaul control connection, and perform the requesting and the establishing in response to the packet-drop ratio exceeding a threshold packet-drop ratio value.

### Supplemental Note 19

In the apparatus of any one of Supplemental Notes 15-17, the circuitry is further configured to provision the distributed unit application on a server in a data center.

### Supplemental Note 20

In the apparatus of Supplemental Note 19, the circuitry is further configured to provision the distributed unit application by initializing the midhaul connection protocol from the distributed unit application to the control unit application to utilize the first midhaul connection protocol address, provisioning the transport layer micro-service to communicate control messages between the distributed unit application and the control unit application, requesting, from the transport layer micro-service through the first midhaul connection protocol address, the first midhaul control connection between the distributed unit application and the control unit application, and establishing the first midhaul control connection.

What is claimed is:

1. A non-transitory computer-readable medium including instructions executable by a processor to cause the processor to perform operations comprising:
transmitting, by a transport layer micro-service through a first midhaul control connection, a control message from the distributed unit application to the central unit application utilizing a first midhaul connection protocol address;
requesting, from the transport layer micro-service through the first midhaul control connection, a second midhaul control connection utilizing a second midhaul connection protocol address;
establishing the second midhaul control connection utilizing the second midhaul connection protocol address; and
transmitting, by the transport layer micro-service through the second midhaul control connection, a control message from the distributed unit application to the central unit application utilizing the second midhaul connection protocol address.

2. The computer-readable medium of claim 1, wherein the establishing the second midhaul control connection includes
associating, by the transport layer micro-service, a device communicating through the distributed unit application with the second midhaul connection protocol address; and
wherein the device is associated with both the first midhaul connection protocol address and the second midhaul connection protocol address.

3. The computer-readable medium of claim 1, wherein the operations further comprise detecting an issue with the first midhaul control connection; and
in response to detecting the issue:
discontinuing transmission of control messages through the first midhaul control connection; and
beginning transmission of control messages through the second midhaul control connection.

4. The computer-readable medium of claim 1, wherein the operations further comprise detecting a packet-drop ratio through the first midhaul control connection; and
performing the requesting and the establishing in response to the packet-drop ratio exceeding a threshold packet-drop ratio value.

5. The computer-readable medium of claim 1, wherein the operations further comprise provisioning the distributed unit application on a server in a data center.

6. The computer-readable medium of claim 5, wherein the provisioning the distributed unit application includes:
initializing the midhaul connection protocol from the distributed unit application to the control unit application to utilize the first midhaul connection protocol address;
provisioning the transport layer micro-service to communicate control messages between the distributed unit application and the control unit application;
requesting, from the transport layer micro-service through the first midhaul connection protocol address, the first midhaul control connection between the distributed unit application and the control unit application; and
establishing the first midhaul control connection.

7. The computer-readable medium of claim 6, wherein the establishing the first midhaul control connection includes associating with the first protocol address, by the transport layer micro-service, a device communicating through the distributed unit application.

8. A method comprising:
transmitting, by a transport layer micro-service through a first midhaul control connection, a control message from the distributed unit application to the central unit application utilizing a first midhaul connection protocol address;
requesting, from the transport layer micro-service through the first midhaul control connection, a second midhaul control connection utilizing a second midhaul connection protocol address;
establishing the second midhaul control connection utilizing the second midhaul connection protocol address; and
transmitting, by the transport layer micro-service through the second midhaul control connection, a control message from the distributed unit application to the central unit application utilizing the second midhaul connection protocol address.

9. The method of claim 8, wherein the establishing the second midhaul control connection includes
associating, by the transport layer micro-service, a device communicating through the distributed unit application with the second midhaul connection protocol address; and
wherein the device is associated with both the first midhaul connection protocol address and the second midhaul connection protocol address.

10. The method of claim 8, further comprising
detecting an issue with the first midhaul control connection; and
in response to detecting the issue:
discontinuing transmission of control messages through the first midhaul control connection; and
beginning transmission of control messages through the second midhaul control connection.

11. The method of claim 8, further comprising
detecting a packet-drop ratio through the first midhaul control connection; and
performing the requesting and the establishing in response to the packet-drop ratio exceeding a threshold packet-drop ratio value.

12. The method of claim 8, further comprising
provisioning the distributed unit application on a server in a data center.

13. The method of claim 12, wherein the provisioning the distributed unit application includes:
initializing the midhaul connection protocol from the distributed unit application to the control unit application to utilize the first midhaul connection protocol address;
provisioning the transport layer micro-service to communicate control messages between the distributed unit application and the control unit application;
requesting, from the transport layer micro-service through the first midhaul connection protocol address, the first midhaul control connection between the distributed unit application and the control unit application; and
establishing the first midhaul control connection.

14. The method of claim 13, wherein the establishing the first midhaul control connection includes
associating with the first protocol address, by the transport layer micro-service, a device communicating through the distributed unit application.

15. An apparatus comprising:
a controller including circuitry configured to:
transmit, by a transport layer micro-service through a first midhaul control connection, a control message from the distributed unit application to the central unit application utilizing a first midhaul connection protocol address;
request, from the transport layer micro-service through the first midhaul control connection, a second midhaul control connection utilizing a second midhaul connection protocol address;
establish the second midhaul control connection utilizing the second midhaul connection protocol address; and
transmit, by the transport layer micro-service through the second midhaul control connection, a control message from the distributed unit application to the central unit application utilizing the second midhaul connection protocol address.

16. The apparatus of claim 15, wherein the establishing the second midhaul control connection includes
associating, by the transport layer micro-service, a device communicating through the distributed unit application with the second midhaul connection protocol address; and
wherein the device is associated with both the first midhaul connection protocol address and the second midhaul connection protocol address.

17. The apparatus of claim 15, wherein the circuitry is further configured to detect an issue with the first midhaul control connection; and
in response to detecting the issue:
discontinue transmission of control messages through the first midhaul control connection; and
begin transmission of control messages through the second midhaul control connection.

18. The apparatus of claim 15, wherein the circuitry is further configured to
detect a packet-drop ratio through the first midhaul control connection, and
perform the requesting and the establishing in response to the packet-drop ratio exceeding a threshold packet-drop ratio value.

19. The apparatus of claim 15, wherein the circuitry is further configured to provision the distributed unit application on a server in a data center.

20. The apparatus of claim 19, wherein the circuitry is further configured to provision the distributed unit application by:
initializing the midhaul connection protocol from the distributed unit application to the control unit application to utilize the first midhaul connection protocol address;
provisioning the transport layer micro-service to communicate control messages between the distributed unit application and the control unit application;
requesting, from the transport layer micro-service through the first midhaul connection protocol address, the first midhaul control connection between the distributed unit application and the control unit application; and
establishing the first midhaul control connection.
